(19) United States
(12) Patent Application Publication
(10) Pub. No.: US 2026/0208872 A1
(43) Pub. Date: Jul. 23, 2026

(54) MOTOR CONTROL WITH TUNABLE NOTCH FILTER

(71) Applicant: BETA AIR LLC, South Burlington, VT (US)

(72) Inventor: Collin Freiheit, South Burlington, VT (US)

(21) Appl. No.: 19/431,670

(22) Filed: Dec. 23, 2025

Related U.S. Application Data
(60) Provisional application No. 63/738,975, filed on Dec. 26, 2024.

(51) Int. Cl. B64D 31/04

(52) U.S. Cl. CPC B64D 31/04

(57) ABSTRACT

An electrically powered aircraft is configured to control its motors with reduced influence of noise generated by each of the motors of the aircraft. The motor control system of the aircraft includes one or more variable frequency notch filters, where the notch of each of the variable frequency notch filters are set to filter out motor noise from control signals of the aircraft. A body torque signal representing the position and/or orientation of the aircraft is subjected to notch filtering, such as filtering out the motor noise corresponding to a primary frequency and a second harmonic frequency of each of the motors of the aircraft. The commutation signals powering each of the motors is based in part on the filtered body torque signal and, as a result, may have a reduced influence from motor noise, resulting in more accurate and/or robust motor control.

### TECHNICAL FIELD

The present disclosure relates to controlling one or more motors by generating motor or torque control signals. More specifically, the present disclosure relates to determining the motor control signals by filtering out effects of the motor operating and generating noise.

### BACKGROUND

Electrical and/or hybrid propelled vehicles, such as an electric and/or hybrid powered aircraft, may be controlled according to feedback signals corresponding to the electric and/or hybrid vehicle position and/or orientation (e.g., pitch, roll, yaw, etc.), as well as operator control. However, the signals used to control the motors of the electric and/or hybrid vehicle may be corrupted by motor noise. The motor noise may represent one or both of mechanical and/or electrical noise from the operation of the motors of the electric and/or hybrid vehicle. Artifacts in motor control signals due to the motor noise can make the control of the motors of the electric and/or hybrid vehicle less accurate and/or less robust. It is thus desirable to reduce and/or remove the effects of the motor noise on the control of the motors of the electric and/or hybrid vehicle.

Attempts have been made to remove motor noise in electric and/or hybrid vehicles, such as by using Kalman filtering. However, such attempts are not effective for removing motor noise that is variable in nature. For example, if the speed of the motor changes, these conventional methods do not dynamically remove motor noise as the operation of the motor changes. Furthermore, conventional methods of removing motor noise do not address motor noise in signals that are used for feedback control of the motor itself.

Examples of the present disclosure are directed toward overcoming one or more of the deficiencies noted above.

### SUMMARY

In an aspect of the present disclosure, a motor control system includes a feedback controller configured to receive an inertial sensor signal and a pilot input signal and generate a body torque signal based at least in part on the inertial sensor signal and the pilot input signal. The motor control system further includes a first variable frequency notch filter configured to filter the body torque signal to generate a filtered body torque signal, wherein the body torque signal is filtered to attenuate a first frequency of rotation of a first motor and first motor controller configured to generate commutation signals for the first motor based at least in part on the filtered body torque signal and power the first motor using the commutation signals.

In further aspects, the motor control system further includes a mixer configured to generate a motor control signal for the first motor based at least in part on the filtered body torque signal, wherein the commutation signals are based at least in part on the motor control signal. In some cases, the motor control system further includes a second variable frequency notch filter configured to filter the body torque signal to attenuate a second harmonic frequency associated with the first frequency of rotation of the first motor to generate the filtered body torque signal. In additional aspects, the motor control system, where a notch frequency of the first variable frequency notch filter is set to the first frequency of rotation of the first motor. In yet additional aspects, the motor control system further includes a second variable frequency notch filter configured to filter the body torque signal to attenuate a second frequency of rotation of a second motor to generate the filtered body torque signal. In still additional aspects, the motor control system further includes a third variable frequency notch filter configured to filter the body torque signal to attenuate a third frequency of rotation of a third motor to generate the filtered body torque signal. In other cases, the motor control system, where to filter the body torque signal to generate the filtered body torque signal further includes receiving an indication of the first frequency of rotation of the first motor. In additional cases, the motor control system, where the body torque signal is one of a roll signal, a yaw signal, or a pitch signal.

In another aspect of the present disclosure, a method includes receiving, by a feedback controller, a inertial sensor signal and determining, by the feedback controller and based at least in part on the inertial sensor signal, a body torque signal. The method further includes filtering, using a variable frequency notch filter, a first frequency from the body torque signal to generate a filtered body torque signal and generating, by a mixer and based at least in part on the filtered body torque signal, a motor control signal to control an operation of a motor.

In further aspects, the method includes generating, by a motor controller and based at least in part on the motor control signal, a commutation signal to power the motor. In other aspects, the method includes filtering, using a second variable frequency notch filter, a second frequency from the body torque signal to generate the filtered body torque signal. In some examples, the method includes receiving an indication of a rotational frequency of the motor, wherein the first frequency is substantially equivalent to the rotational frequency of the motor. In some cases, the method includes determining, by a second feedback controller and based at least in part on the inertial sensor signal, a second body torque signal, filtering, using a second variable frequency notch filter, a second frequency from the second body torque signal to generate a second filtered body torque signal, and generating, by a second mixer and based at least in part on the second filtered body torque signal, a second motor control signal to control the operation of a second motor. In yet other cases, the method includes receiving, by a second feedback controller, a second inertial sensor signal and determining, by the second feedback controller and based at least in part on the second inertial sensor signal, a second body torque signal. The method further includes filtering, using a second variable frequency notch filter, a second frequency from the second body torque signal to generate a second filtered body torque signal and generating, by a mixer and based at least in part on the second filtered body torque signal, a second motor control signal to control the operation of a second motor.

In yet another aspect of the present disclosure, an aircraft includes a motor and one or more controllers configured to filter a first frequency from a body torque signal to generate a filtered body torque signal, the first frequency corresponding to a rotational frequency of the motor, generate, based at least in part on the filtered body torque signal, a motor control signal to control an operation of a motor, and generate, based at least in part on the motor control signal, a commutation signal to power the motor.

In some cases, the aircraft, where the one or more controllers are configured to filter a second frequency from the body torque signal to generate the filtered body torque signal, the second frequency corresponding to a second harmonic of the rotational frequency of the motor. In other cases, the aircraft, where the one or more controllers are configured to filter a second frequency from the body torque signal to generate the filtered body torque signal, the second frequency corresponding to a rotational frequency of a second motor. In some aspects, the aircraft, where the one or more controllers are configured to filter a third frequency from the body torque signal to generate the filtered body torque signal, the second frequency corresponding to a second harmonic of the rotational frequency of the second motor. In other aspects, the aircraft, where the one or more controllers are configured to filter the first frequency from a second body torque signal to generate a second filtered body torque signal, generate, based at least in part on the second filtered body torque signal, a second motor control signal to control an operation of a second motor, and generate, based at least in part on the second motor control signal, a second commutation signal to power the second motor. In still other aspects, the aircraft, where the one or more controllers are configured to filter a second frequency from the second body torque signal to generate the second filtered body torque signal, the second frequency corresponding to a rotational frequency of the second motor.

### BRIEF DESCRIPTION OF DRAWINGS

FIG. 1 is a block diagram of an example electric vertical takeoff and landing (eVTOL) aircraft, according to examples of the disclosure.

FIG. 2 is a schematic block diagram of an example motor control mechanism of the eVTOL aircraft of FIG. 1, according to examples of the disclosure.

FIG. 3 is a flow diagram depicting an example method to generate motor control signals by filtering body torque signals using notch filters, according to examples of the disclosure.

FIG. 4 is a chart depicting an example output transfer function of a notch filter used to generate a motor control signal of the eVTOL aircraft of FIG. 1, according to examples of the disclosure.

FIG. 5 is an example block diagram depicting the generation of an example filtered body torque signal of a motor of the eVTOL aircraft of FIG. 1 over time, according to examples of the disclosure.

FIG. 6 is a block diagram of a controller to generate a filtered body torque signal of a motor of the eVTOL aircraft of FIG. 1, according to examples of the disclosure.

### DETAILED DESCRIPTION

Wherever possible, the same reference numbers will be used throughout the drawings to refer to the same or like parts.

The disclosure herein is directed to systems, methods, and apparatus for motor control in an aircraft to control the aircraft's movements. In examples of the disclosure, motor(s) may be controlled by generating motor control signal(s) in a vehicle, such as an aircraft, such as an electric vertical takeoff and landing (eVTOL) aircraft and/or in a conventional takeoff and landing (CTOL) aircraft. The motor control signal(s) may be based on one or more other signals, such as signals indicative of the body torque of the eVTOL or other aircraft, such as inertial sensor signal(s). For example, signals from initial sensor(s) (e.g., accelerometers, gyros, etc.) may be used to control the position and body torque of the aircraft. According to examples of the disclosure, motor noise may be filtered from one or more control signals, such as body torque signal(s) that may be used to control one or more motor(s) of the aircraft.

Although disclosed in the context of an eVTOL aircraft, it should be understood that the disclosure herein may be applied to any situation where mechanical and/or electrical noise generated by a motor may interfere in the feedback control of that or other motor(s). For example, if one of a plurality of motors of an eVTOL aircraft were to be controlled to cause a desired action (e.g., a particular movement of the aircraft or hovering of the aircraft), the mechanical and/or electrical noise from the motors themselves may interfere, at least in part, with control of those motors. In some cases, body torque signals may be generated using a feedback control (e.g., such as with a proportional-integral-derivative (PID) controller) of one or more positional and/or orientation measurements of the aircraft. The body torque signals may be indicative of one or more measures of torque of the aircraft. For example, the body torque signals may include a pitch signal, a yaw signal, a roll signal, or the like. Although certain measures of position and/or body torque of the aircraft, such as cartesian coordinates, pitch, yaw, roll, or the like, are used herein, it should be understood that any suitable measures (e.g., other eigenvectors and corresponding eigenvalues) may be used to define the position and/or body torque/orientation of the aircraft.

The body torque signals may be generated based on other signals, such as inertial sensor signals, such as inertial sensor signals generated using inertial sensors (e.g., accelerometers, microelectromechanical system (MEMS)-based position sensors, gyros, etc.). The inertia sensor signals may be fed into a feedback controller, such as a proportional-integral-derivative (PID) controller. The feedback controller may also receive pilot input signals, indicative of desired movements of the aircraft. The feedback controller may output the body torque signals, which, in turn, is used to generate motor control signals to control the motors of the aircraft. However, the body torque signals may include noise from the motors of the aircraft, in some cases due to motor noise in the inertial sensor signals. These noise artifacts in the body torque signals affect the motor control signals. As such, the motor noise injects artifacts and/or errors in the one or more signals used to control the motors of the aircraft. In other words, the motor noise may make the control of motors of the aircraft less accurate and/or less robust. The motor noise may manifest as mechanical noise, as captured by the inertial sensors in the inertial sensor signals, and/or electrical noise, as captured by any variety of electrical components in the control infrastructure of the motors of the aircraft. In other words, motor noise includes undesired signal content that does not correlate to rigid body motion of the vehicle and is not useful information for the control systems that control the operation of the motors.

According to examples of the disclosure, the body torque signals, as generated based at least in part the inertial sensor signals and pilot control signals, may be filtered to remove and/or reduce the motor noise from the body torque signals, which in turn, are used to generate the motor control signals. In this way, the influence of motor noise on the motor control signals are reduced and/or removed without significantly affecting the sensed dynamic response of the rigid body of the eVTOL aircraft. As a result, the control of the motors of the aircraft may be less, and often significantly less, influenced by motor noise. Accordingly, the control of the motors may be more accurate and/or robust for the desired movements of the aircraft, than if the motor noise artifacts were not removed.

The motor noise may be removed from the body torque signals using variable frequency notch filters. The notch frequency, or the center frequency, of each of the notch filters may be set to the frequency of each of the operational motors, such as the motors that power the rotors of the aircraft. For example, if there are four rotors on the eVTOL aircraft, then four notch filters may be used to filter out the frequency of rotation of each of the four motors powering the rotors. In other cases, there may be more or fewer motors powering rotors on the aircraft, and regardless of the number of motors, the fundamental frequency of all or some of the motors may be filtered out from the body torque signals. In yet other case, the second harmonic frequency of each of the motors may also be filtered out of the torques signals. In still other cases, other higher order harmonic frequencies and/or intermodulation frequencies may be filtered out of the torque signals.

In one non-limiting example, the eVTOL aircraft may have four lift rotors, each driven by a motor. The body torque signals used to determine the motor control signals may include a roll signal, a pitch signal, and a yaw signal. Each of the body torque signals, in the form of the roll signal, the pitch signal, and the yaw signal may be filtered with eight different notch filters per signal to filter out the primary and second harmonic frequency of each of the four lift motors. Thus, filtered body torque signals, in the form of a filtered roll signal, a filtered pitch signal, and a filtered yaw signal, may be generated by filtering out the first and second harmonic of the lift rotor motor rotational frequencies. The filtered body torque signals may then be used to generate motor control signals that are provided to motor controllers corresponding to each of the motors. The motor controllers of each of the motors receives the motor control signals and use the motor control signals to generate commutation signals that provide timing and power to operate the motors.

The rotational frequency of each of the motors of the eVTOL aircraft may be determined by any suitable mechanism. For example, the motor speed may be determined by identifying the fundamental frequency of the commutation signals being provided to the motors. In other examples, a motor speed sensor may provide an indication of the motor rotational speed of the various motors of the eVTOL aircraft. In sensorless configurations of the motor controller, back-electromotive force (EMF) may be measured and used to determine the rotational speed of each of the motors. In still other cases, the body torque signals themselves may be analyzed to determine the rotational frequency of the motors, as there may be an increased level (e.g., a spike) in the noise at those frequencies at which the motors are spinning. Thus, that increased level of noise may be used to identify the motor speed to provide to the notch filter(s) to tune the notch of the notch filter(s). There may be any other variety of ways to determine the motor noise generated in the body torque signals, any of which may be used to tune the notch filters to filter out the desired frequencies in the body torque signals.

The notch filters, as discussed herein, may be digital notch filters, where a notch frequency and/or center frequency may be provided thereto to be filtered. In this case, the body torque signals, such as in the form of pitch signals, yaw signals, and/or roll signals, may be discrete time-series signals. In alternative cases, the torque signal(s) may be continuous signals. When the various torque signal(s) are continuous and/or analog, the notch filters may also be analog devices, such as tunable inductive-capacitive (LC) notch filters, resistive-inductive (RL) notch filters, and/or tunable resistive-inductive-capacitive (RLC) notch filters.

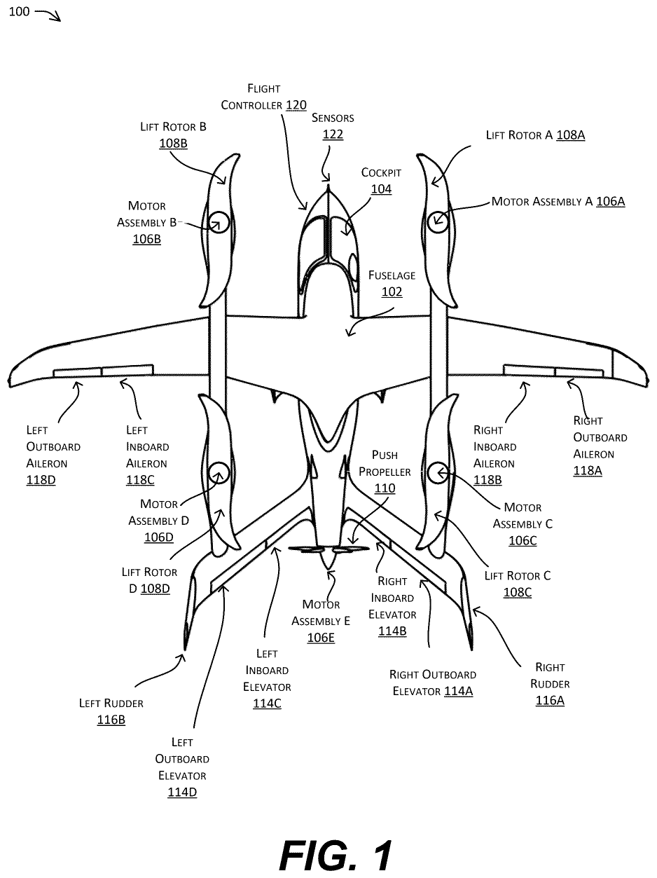

FIG. 1 is a block diagram of an example electric vertical takeoff and landing (eVTOL) aircraft 100, according to examples of the disclosure. The aircraft 100 includes a fuselage 102 and a cockpit 104 to carry passengers and/or a pilot. In alternate cases, the aircraft 100 may be unmanned and controlled remotely. In some cases, the aircraft 100 may have a fly-by-wire control system.

Although, discussed in the context of an eVTOL aircraft 100, it should be understood that the disclosure herein may be applied to any use case where the operation and/or feedback control of a motor, such as a permanent magnet synchronous motor (PMSM), is to be is to be performed in an operational environment. Thus, the disclosure may be applied to any variety of transportation applications, such as electric watercrafts, electric cars, electric heavy machinery, electric trucks, electric trains, electric busses, or the like. The disclosure herein may also be applied outside of the realm of transportation, such as in appliances, power tools, or the like.

The aircraft 100 may include motor assembly A 106A, motor assembly B 106B, motor assembly C 106C, motor assembly D 106D, and motor assembly E 106E, hereinafter referred to in the singular as motor assembly 106 or in the plural as motor assemblies 106. The motor assemblies 106 may be positioned to balance thrust and/or lift distribution across the aircraft 100. In some embodiments, one or more of the motor assemblies 106 may be configured for redundancy or for failover purposes. For example, in some cases, if motor assembly A 106A were to fail and/or operate at a reduced capacity, a set of other motor assemblies (e.g., motor assembly B 106B, motor assembly C 106C, and/or motor assembly D 106D) may be configured to compensate for the reduced and/or lost operational capacity of motor assembly A 106A.

The motor assemblies 106 may be configured to drive (e.g., rotate) one or more propulsors, such as lift rotors 108A, 108B, 108C, 108D, hereinafter referred to in the singular as lift rotor 108 or in the plural as lift rotors 108, and/or a push propeller 110. For example, motor assembly A 106A may be configured to drive the lift rotor A 108A, motor assembly B 106B may be configured to drive the lift rotor B 108B, motor assembly C 106C may be configured to drive the lift rotor C 108C, motor assembly D 106D may be configured to drive the lift rotor D 108D, and motor assembly E 106E may be configured to drive the push propeller 110. In some examples, lift rotors 108 may be configured to enable the vertical takeoff of the aircraft 100, while the push propeller 110 may be configured to enable the horizontal movement of the aircraft.

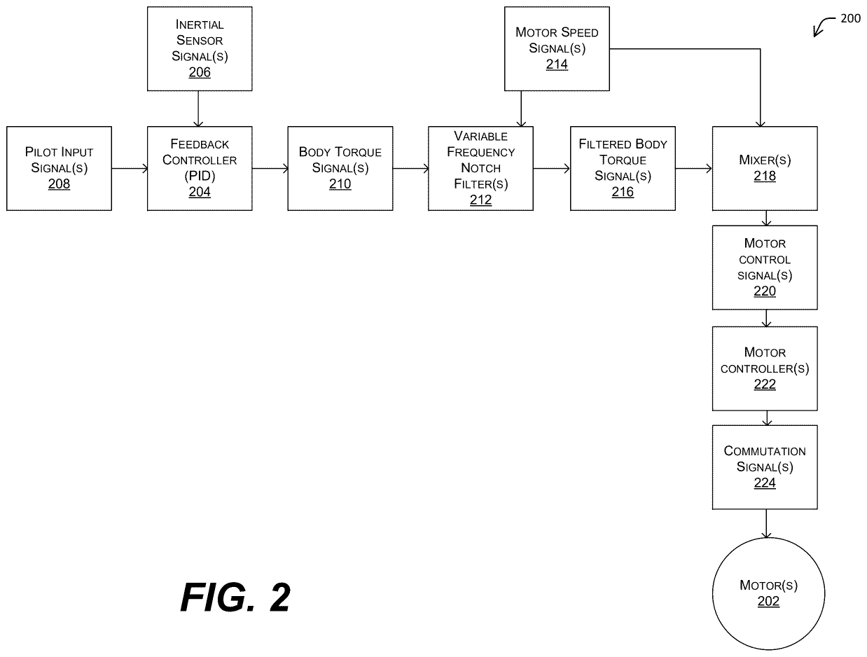

The motor assemblies 106 may include an electric motor and associated hardware and software to control the operation of the motor assemblies 106, as will be discussed in conjunction with FIG. 2. The aircraft 100 may include one or more energy sources such as one or more batteries (not shown) to store electric energy that is used to energize the motor assemblies 106 to drive their corresponding lift rotors 108 and/or push propeller(s) 110. For example, a battery may store electrical energy and provide that energy, as controlled by the components of the motor assembly 106 to provide direct current (DC) electric power to power motors of the motor assemblies 106 to rotate the corresponding lift rotors 108 and/or push propeller 110. The motor assemblies 106 may operate at any suitable voltage, current, and/or power. For example, the motor assemblies may operate in a voltage range of about 25 volts to about 500 volts and a current range of about 10 Amps to about 100 Amps. In some cases, the operating voltage range of about 50 volts to about 300 volts and a current range of about 20 Amps to about 40 Amps. An inverter, as provided within a motor controller, may convert the DC electric power stored by a battery into alternating current (AC) power and/or pulse width modulated (PWM) power and provide the AC and/or PWM power to the motors in each of the motor assemblies 106 as commutation signals.

The aircraft 100 includes a set of control surfaces, such as a right outboard elevator 114A, right inboard elevator 114B, left inboard elevator 114C, and left out board elevator 114D, hereinafter referred to in the singular as elevator 114 or in the plural as elevators 114. The elevators 114 are configured to control the pitch of the aircraft 100. In some cases, the elevators 114 on both sides of the aircraft 100 may be partitioned into two or more components to provide more precise control over the pitch of the aircraft 100 and/or to provide redundancy in the event of any component failure. For example, in some embodiments, having two or more elevators 114 on each side enables independently controlling those elevators 114 to enable more fine-tuned control over the pitch of the aircraft 100. Additionally, in the event of failure of a first elevator 114 on one side, a second elevator 114 on the same side may enable control of the pitch of the aircraft 100 on that side to mitigate the effects of the failure.

Additional control surfaces of the aircraft 100 include a right rudder 116A and left rudder 116B, hereinafter referred to in the singular as rudder 116 or in the plural as rudders 116, to control yaw of the aircraft 100. Although, unlike the elevators 114, the rudders 116 of the aircraft 100 are not depicted as partitioned on two sides it should be understood that in some airframe embodiments, the rudders 116 of the aircraft 100 may be partitioned on one or both sides. Still further, the aircraft 100 may include a right outboard aileron 118A, a right inboard aileron 118B, a left inboard aileron 118C, and a left outboard aileron 118D, hereinafter referred to in the singular as aileron 118 or in the plural as ailerons 118, to generate lift or drag. Any of the control surfaces 114, 116, 118 may be of more or less numbers and may be controlled by a pilot, a remote operator, or a bot, either directly or indirectly (e.g., fly-by-wire). Each of the control surfaces 114, 116, 118 may be controlled using one or more actuators (not shown).

As further depicted in FIG. 1, the aircraft 100 includes a flight controller 120. The flight controller 120 may include one or more flight controller components (e.g., one or more flight control computers (FCCs)) configured to generate command signal(s) that control the operation of various components of the aircraft 100. For example, the flight controller unit 120 may be configured to generate command signal(s), such as motor control signal(s), that control the operation of one or more inverters that provides electrical power and/or commutation within the motor assemblies 106 of the aircraft 100, an actuator that controls the operation of at least one control surface 114, 116, 118 of the aircraft 100, and/or the like.

A pilot (not shown) or other operator of the aircraft 100 may be in the cockpit 104 of the aircraft 100 to control the operation (e.g., speed, direction, altitude, etc.) of the aircraft 100. The pilot may interact with a variety of control devices (not shown) within the cockpit 104 to control the actions of the aircraft 100. The control devices may be configured to detect a pilot action and transmit pilot input data representing a desired action of the aircraft 100 (e.g., an electrical signal encoding the detected desired action) to the flight controller 120. A pilot control device may include a throttle lever, an inceptor stick, a lift lever, a steering wheel, a brake pedal, a pedal control, a toggle, a joystick, a collective pitch control device, an alpha-numeric input device (e.g., a keyboard), a pointing device, an audio input device (e.g., a microphone, a voice response system, etc.), a cursor control device (e.g., a mouse), a touchpad, an optical scanner, a video capture device, a touchscreen, and/or the like.

The flight controller 120 may identify inputs from the pilot and/or remote operator via one or more control devices and use those inputs to control various components of the aircraft 100. The aircraft 100 may perform the actions desired by the pilot and/or remote operator by way of commands generated by the flight controller 120 to move control surfaces 114, 116, 118 and/or control the motor assemblies 106. In some cases, the flight controller 120 may also receive signals from sensor(s) 122. The sensors 122 may provide a variety of information to the controller 120, such as location (e.g., latitude, longitude, altitude, etc.), obstructions, temperature, humidity, other environmental factors, etc. The flight controller 120 may be configured to change the operation of the aircraft 100 responsive to signals from the sensors 122.

The flight controller 120 may include a microprocessor, a digital signal processor (DSP), a system on a chip (SoC), a field-programmable gate array (FPGA), a complex programmable logic device (CPLD), an application specific integrated circuit (ASIC), a multi-chip module, a printed circuit board, and/or the like. In some embodiments, the flight controller 120 is configured to receive one or more pilot input signals from one or more pilot control devices, perform one or more signal processing operations (e.g., one or more time-frequency analysis operations) on the pilot control signal(s) to generate one or more transformed signals, and determine the pilot command signal based on the transformed signal(s). In some examples, the flight controller 120 may use one or more trained machine learning models to perform the signal processing operation(s) on pilot control signal(s) and/or sensor signal(s) to generate commands for various components of aircraft 100.

As described above, in some cases, the flight controller 120 may determine one or more command signals for controlling the aircraft 100 and/or a trajectory generated for the aircraft 100 based on sensor data provided by the sensor(s) 122. The sensor(s) 122 may include vision sensor(s), depth sensor(s) (e.g., LiDAR sensor(s)), torque sensor(s), gyroscope(s), accelerometer(s), magnetometer(s), inertial measurement unit(s) (IMU(s)), pressure sensor(s), force sensor(s), proximity sensor(s), displacement sensor(s), vibration sensor(s), environmental sensor(s), and/or the like.

The flight controller 120 may further be configured to provide a variety of control signals to the motor assemblies 106 to control their respective lift rotors 108 and/or push propellers 110. For example, the flight controller 120 may cooperate with one or more controllers of the motor assemblies 106 to provide an enable signal to enable the operation (e.g., active powered operation) of the motor assemblies 106.

In some cases, the flight controller 120 may provide the functionality, as disclosed herein, to control the motor assemblies with a reduced and/or eliminated influence of the motor noise present during the operation of the motors. In other words, the flight controller 120 may generate the motor control signal(s) sent to each of the motor controllers, which in turn generate commutation signals to drive each of the motor assemblies 106. In other words, the flight controller 120 may remove motor noise by notch filtering the fundamental, second harmonic, and/or any higher order harmonic and/or intermodulation frequency corresponding to motor noise. Alternatively, the flight controller 120 may cooperate with other hardware and/or electronics to generate the motor control signal(s) with reduced and/or eliminated influence of motor noise, as disclosed herein. In examples of the disclosure, the flight controller 120 and/or associated electronics may generate the motor control signal(s) using body torque signal(s) from which the motor noise has been filtered out using tunable notch filters.

The motor assemblies 106, as disclosed herein, may be configured to operate in a synchronized or closed loop manner, where the position of the motor is used as feedback to provide control signals (e.g., commutation signals) to the various phases of the motor. The motor assemblies 106 may also be configured to operate in an open loop manner, without position feedback. In open loop operation, the motor is only controlled using the commutation signals, without the benefit of positional feedback from the motor.

It should be understood that the motor assemblies 106 may not include a position sensor. The control mechanisms and related control laws may not use a position sensor for synchronization of the motor assembly 106. Instead, the motor assembly, and the synchronization thereof, may be controlled using back-EMF and/or current and/or voltage measurements at the various phases of the motor assembly 106. The position of the motor, as used herein, refers to the position of the rotor of the motor relative to the stator. It should be understood that the position of the motor may be referred to by any other suitable terms, such as rotor position, motor angle, rotor angle, motor phase, rotor phase, or the like.

According to examples of the disclosure, the flight controller 120 and/or associated electronics may notch, or filter out certain frequencies corresponding to the speed of rotation of one or more of the motor assemblies 106 from one or more body torque signal(s) and/or from signals used to generate the body torque signals, such as inertial sensor signal(s). The indication of the motor speed may be received by the flight controller 120 and/or associated electronics from the motor assemblies 106 themselves. The motor assemblies 106 may provide an indication of its commutation frequency and/or measured angular frequency of its corresponding motors, as measured using any variety of sensors or sensorless mechanism. In some cases, back-electromotive force (EMF) generated by the spinning motor, which is generally proportional to the angular velocity of the motor, may be used to determine the motor rotational frequency. In other cases, the flight controller 120 and/or associated electronics may determine the rotation frequency of each of the motor assemblies 106 by monitoring regions of excessive noise and filtering those frequencies. By filtering out motor noise, the flight controller 120 may generate more accurate and/or robust motor control signal(s) provided to one or more motor controller(s) to control the motors of the eVTOL aircraft 100.

Although discussed in the context of the eVTOL aircraft 100, it should be understood that the apparatus, systems, and methods disclosed herein to reduce the influence of noise from the motors assemblies 106 on the control of those same motor assemblies 106. For example, the mechanism for motor control by notch filtering motor noise from control signal(s) may be applied to a conventional takeoff and landing (CTOL) aircraft or other transportation vehicles or other non-transportation applications.

FIG. 2 is a schematic block diagram of an example motor control mechanism 200 of the eVTOL aircraft 100 of FIG. 1, according to examples of the disclosure. It should be understood that some or all of the components of the motor control mechanism 200 may be incorporated within the flight controller 120. In other cases, some or all of the components of the motor control mechanism 200 may be sperate electronic components from the flight controller 120 and may cooperate with the flight controller 120 to provide motor control with reduced effects of motor noise, as disclosed herein.

The motor control mechanism 200 may include a motor 202 that provides rotational motion of the motor assembly 106 for any variety of purposes, such as to rotate the lift rotors 108 and/or the push propellers 110. The motor 202 may be of any suitable type, such as a permanent magnet synchronous motor (PMSM). Alternatively, the motor 202 may be any suitable DC or AC motor, such as brushed, brushless, synchronous, induction, switched-reluctance, or the like. The motor 202 may have any suitable topology and/or number of phases. For example, the motor 202 may have three phases that are separated by 120° (2π/3 radians). Alternatively, the motor may have six phases that are separated by 60° (π/3 radians). Indeed, the motor 202 may have any suitable number of phases, split-phases, or the like.

The motor 202 may include a stator with coils that energize in a rotating fashion to rotate a permanent magnet, which can also be referred to as the rotor. The permanent magnet of the motor 202 may be of any suitable type and/or material of construct, such as neodymium magnets, samarium cobalt magnets, alnico magnets, and/or ferrite magnets. The motor 202, as discussed herein, may generate noise during its operation. The source of the noise may be electrical and/or mechanical. Mechanical noise may be in the form of vibrations related to the operation of the motor 202 that influence mechanical measurements, such as measurements by sensors 122. For example, accelerometers of the eVTOL aircraft 100 may provide signals indicative of the eVTOL aircrafts location and/or torque, where those signals may include mechanical noise from the operation of the motor 202. Thus, the motor noise may manifest as vibrations from the operation of the lift rotors 108 and/or push propellors 110 and/or any source of vibration, as measured by the sensors 122. Electrical noise may result from the switching of the phases of the motor 202, magnetization and demagnetization of the phases of the motor 202, from the generation of the commutation signals to drive the motor 202, and/or the like. Electrical noise may affect other electronic components of the eVTOL aircraft, where components may act as an antenna that receives electrical motor noise. As discussed herein, the motor noise, whether electrical, mechanical, or both electrical and mechanical, may affect and/or reduce the ability and/or accuracy to control the motor 202 in a feedback mechanism.

A feedback controller 204, such as a PID controller, may receive inertial sensor signal(s) 206, such as from the sensors 122, as well as pilot input signal(s) 208, indicative of a pilot's intended movement of the eVTOL aircraft 100. The feedback controller 204 may generate body torque signal(s) 210 based at least in part on one or both of the inertial sensor signals 206 and/or pilot input signals 208. As discussed herein, the feedback controller 204 may be any suitable controller that receives an indication of the eVTOL aircraft's current position and/or orientation (e.g., body torque), as well as desired movements and/or orientation of the eVTOL aircraft 100 to generate control signals or precursors to control signals, such as the body torque signals 210. The inertial sensor signals 206 may be generated by any suitable type of sensors 122, such as accelerometers, gyros, or the like. Additionally, the pilot inputs may be encoded into the pilot input signals 208. Thus, the body torque signals 210 incorporate one or both of the eVTOL's current position and/or orientation, as well as its desired movements.

It will be understood that the initial sensor signals 206 and/or the pilot input signals 208 may be corrupted with motor noise. Thus, the motor noise from one or both of the inertial sensor signals 206 and/or pilot signals 208 can manifest in the body torque signals 210 as motor noise induced artifacts. These artifacts are undesirable because artifacts, as induced by motor noise, corrupt the true body torque signal without the influence of motor noise. As a result, the motor noise can introduce errors in the control of the motors based on feedback signals. In other words, the motor noise causes a deviation in the control of the motors 202 of the eVTOL aircraft 100 from the desired control without the influence of motor noise. Thus, filtering out the motor noise from the body torque signals 210 can improve the control of the motors 202 of the eVTOL aircraft 100.

To filter out the motor noise from the body torque signals 210, the torque signals 210 may be provided to one or more variable frequency notch filters 212. Each of the variable frequency notch filters 212 may be provided with an indication of a notch frequency that is to be filtered by individual ones of the variable frequency notch filters 212. In some cases, the primary frequency of each of the motor assemblies 106 of the lift rotors 108 may be filtered out of the body torque signals 210. In these cases, the rotational frequencies (e.g., primary frequencies, harmonics, intermodulation frequencies, etc.) of the motor assembly 106E of the push propeller 110 may not be filtered out from the torque signals 210 due to the rotational frequency of the push propeller 110 being different enough from the motor assemblies 106 of the lift rotors 108 for those frequencies to not significantly interfere with the feedback control of the motors 202. In alternative cases, the frequencies associated with the push propeller 110 may also be filtered out of the body torque signals 210.

In some examples, the second harmonic frequency (e.g., 2× the primary frequency of rotation) of each of the motors 202 of the lift rotors 108 may also be filtered out of the body torque signals 210. In these cases, as both the primary and second harmonic frequencies for each of the motors 202 of the lift rotors 108 are to be filtered out from the torque signals, there may be eight distinct frequencies to be filtered out from the body torque signals 210 corresponding to the four lift rotors 108. In other examples, the fundamental and second harmonic frequencies of the push propeller 110 may also be filtered, resulting in ten different frequencies to filter out from the body torque signals 210. It should be understood that the number of frequencies to be filtered out may depend on the number of lift rotors 108 and/or push propellers 110 on the eVTOL aircraft 100.

Variable frequency notch filter(s) 212 may be used to filter out the frequencies corresponding to motor noise from the body torque signals 210. The variable frequency notch filters 212 may be discrete electronic components, or may be implemented within the flight controller 120 and/or other controllers. If there are eight frequencies to be filtered out (e.g., primary and second harmonic of all of the lift rotor 108 associated motors 202), then there may be eight notch filters 212, each set to filter a particular one of the eight frequencies to be filtered. It will be understood that more or fewer numbers of frequencies may be filtered out of the body torque signals 210. The variable frequency notch filters 212 may be provided with an indication of each of the frequencies for individual ones of the variable frequency notch filters 212 to filter, such as by an indication of frequency carried in motor speed signal(s) 214. Thus, individual variable frequency notch filters 212 may have their notch frequencies set according to the motor speed signals.

As a non-limiting example, if one of the motors 202 of the eVTOL has a primary frequency of 3 Hertz (Hz), equivalent to a motor rotation speed of 180 rotations per minute (RPM), then a first notch filter 212 may be tuned to filter a notch frequency of 3 Hz (primary frequency of the speed of the motor 202) and a second notch filter 212 may be tuned to filter a frequency of 6 Hz (second harmonic of the speed of the motor 202). In this way, both the 3 Hz frequency and the 6 Hz frequency (and a bandwidth of frequencies surrounding each of the notch frequencies) may be filtered out to the body torque signals 210. In implementation, if there are three different body torque signals 210 (e.g., pitch signal, yaw signal, roll signal), then there may be six different notch filters 212 to filter out the primary frequency and the second harmonic frequency from each of the three different torque signals 210.

After notch filtering by the variable frequency notch filters 212, filtered torque signal(s) 216 may be generated. These filtered body torque signals 216 have a reduced influence of the motor noise from the motors 202 of the eVTOL aircraft 100 compared to body torque signals 210. Therefore, any downstream evaluations and/or processes made on the basis of the filtered body torque signals 216 will have a reduced influence from motor noise. As discussed herein, the number of frequencies that are “notched out” or filtered may vary. In some cases, only the primary frequency associated with the motors 202 of the lift rotors 108 may be filtered out from the body torque signals 210 to generate the filtered body torque signals 216. In other cases, the primary frequency, as well as the second harmonic frequency associated with the motors 202 of the lift rotors 108 may be filtered out from the body torque signals 210 to generate the filtered body torque signals 216. In yet other cases, the primary frequency, as well as any number of harmonic and/or intermodulation frequencies associated with the motors 202 of the lift rotors 108 may be filtered out from the body torque signals 210 to generate the filtered body torque signals 216. In still other cases, the primary frequency, and optionally any number of harmonic and/or intermodulation frequencies associated with the motors 202 of the lift rotors 108, as well as motors 202 of the push propeller 110 may be filtered out from the body torque signals 210 to generate the filtered body torque signals 216.

The filtered body torque signals 216 may then be input into one or more mixers 218, along with an indication of motor speed, such as the motor speed signals 214, to generate the motor control signal(s) 220. The motor control signals 220 may indicate the desired operation of one or more motors 202 of the eVTOL aircraft 100. For example, the motor control signals 220 may indicate a particular speed at which the motor 202 is to rotate and/or if the motor 202 is to be sped up or slowed down. The motor control signals 220 may be provided to one or more motor controller(s) 222, which in turn, generate commutation signals 224 to power and control the operation of the motor 202. According to examples of the disclosure, to the extent that the filtered body torque signals 216 have a reduced influence of motor noise compared to conventional techniques, by extension, the motor control signals 220, as well as the commutation signals 224 also have a reduced influence of motor noise compared to conventional techniques.

The motor controllers 222 include an inverter (not shown) that provides power to the motor 202. The inverter may include hardware and software that cooperate to provide power to the motor 202 as the commutation signals 224. Commutation signals 224, as used herein, refer to signals that provide both timing and power to the motor 202 to enable the motor 202 to rotate, such as to cause the rotor of the motor 202 to rotate relative to the stator of the motor 202. The inverter may include switched power electronics, such as metal-oxide-semiconductor field effect transistors (MOSFETs) (not shown) or other transistors or switches. The MOSFETs may be arranged as various legs of the inverter, where each leg provides commutation signals 224 to each phase of the stators of the motor 202. In other words, the MOSFETs may be switched in such a manner as to energize the phases of the motor 202 in succession to rotate the permanent magnet of the motor 202. The commutation signals 224 from the MOSFETs may be in any suitable form, such as pulse width modulated (PWM).

The motor controllers 222 may include current sensor(s), voltage sensor(s), or the like. These electrical sensors may measure various currents, voltages, power, or the like, such as back-EMF current. These measurements may be used to determine the rotor position over time of the motor 202 and/or motor rotational frequency. The motor speed signals 214, indicative of the current speed of the motor 202, and as used for setting the notch of the notch filters 212 and for generating the motor control signals 220, indicating the frequencies associated with the motors 202 of the eVTOL aircraft 100, may be received from any suitable entity. In some cases, the motor speed signals may be received from the various motor controllers 222 that drive each of the motors 202 of the eVTOL aircraft 100. In other cases, other entities may provide an indication of the motor speed and/or rotational frequency. In some cases, the noise may be detected in the body torque signals 210 themselves. For example, if certain frequencies appear to have a spike in noise, then those frequencies may be considered the motor noise and filtered out using the notch filters 212.

In alternative examples, one or more signals other than the body torque signals 210 may be filtered for removal of motor noise. For example, in some cases, the motor noise may be filtered out of the inertial sensor signal(s) 206, before providing the same to the feedback controller 204, to generate the body torque signals 210. If the motor noise is filtered out of the inertial sensor signals 206, then the body torque signals 210 generated therefrom may have a reduced influence of motor noise. In other cases, the pilot input signals 208 my be filtered to remove motor noise. In yet other cases, both the inertial sensor signals 206 and the pilot input signals 208 may be conditioned to remove motor noise prior to generating the body torque signals 210 therefrom. In still other cases, either or both of the inertial sensor signals 206 and the pilot input signals 208 may be conditioned to remove motor noise prior to generating the body torque signals 210 therefrom, and then motor noise may additionally be removed from the body torque signals 210 to generate filtered body torque signals 216.

It should be understood that the disclosure herein enables continuous and/or periodic generation of control signals 220 of the motor(s) 202 of the eVTOL aircraft 100 or any other suitable application. The apparatus, systems, and methods disclosed allow for robust and/or accurate feedback control, with reduced influence of motor noise, of the motors 202 of aircrafts, such as electric aircrafts 100. The disclosure allows full control of motors 202 with less operational errors of the motors 202 due to motor noise, compared to conventional methods. The filtering of the motor noise, unlike conventional methods, is directed to control signals 220 for controlling the motor(s) 202 themselves, where the filtered frequencies change dynamically as the motor operations (e.g., speed) change.

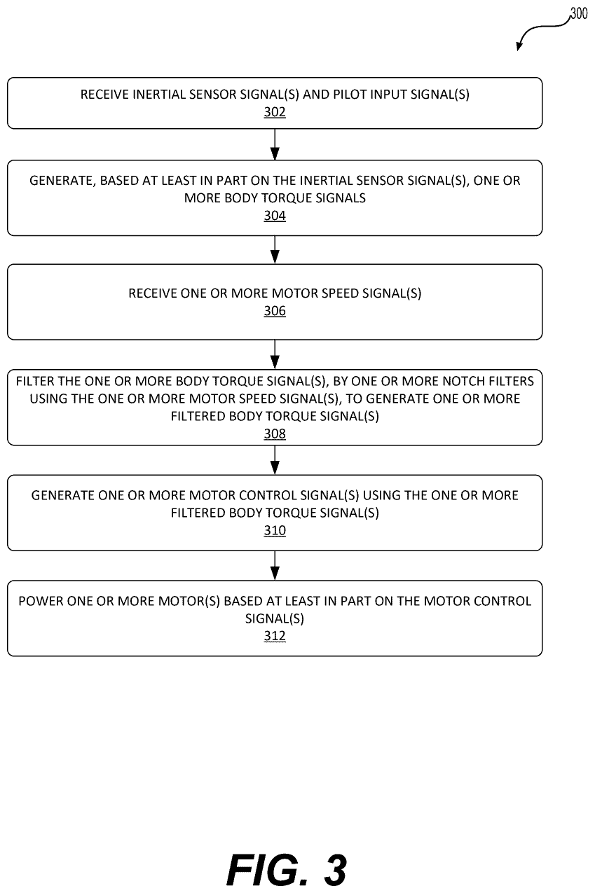

FIG. 3 is a flow diagram depicting an example method to generate motor control signals by filtering body torque signals using notch filters, according to examples of the disclosure. The processes of method 300 may be performed by the flight controller 120 and/or other associated electronic components, individually or in conjunction with one or more other elements of motor control mechanism 200. Alternatively, the method 300 may be performed by any other suitable controller. Method 300 allows the control of motors 202 of the eVTOL aircraft 100, with a reduced and/or no influence of motor noise, such as from the motor assemblies 106.

At block 302, inertial sensor signal(s) and/or pilot input signal(s) may be received, such as by the flight controller and/or other associated electronics. The inertial sensor signals 206 may be received from any variety of sensors 122, such as multi-axis accelerometers, gyros, GPS receivers, or the like. The inertial sensor signal 206 may represent the current position and/or orientation of the eVTOL aircraft 100 and may be used for feedback control. In other words, current positional information about the eVTOL aircraft 100, as embodied in the inertial sensor signals 206, may be used to determine the operations of the motors 202 to enable a desired movement of the eVTOL aircraft 100, as indicated in the pilot input signals 208.

At block 304, one or more body torque signals may be generated based at least in part on the inertial sensor signals and/or the pilot input signals, such as by the flight controller and/or other associated electronics. A feedback controller 204, such as a PID controller, may receive inertial sensor signal(s) 206, such as from the sensors 122, as well as pilot input signal(s) 208, indicative of a pilot's intended movement of the eVTOL aircraft 100. The feedback controller 204 may generate body torque signal(s) 210 based at least in part on one or both of the inertial sensor signals 206 and/or pilot input signals 208. As discussed herein, the feedback controller 204 may be any suitable controller that receives an indication of the eVTOL aircraft's current position and/or orientation (e.g., body torque), as well as desired movements and/or orientation of the eVTOL aircraft 100 to generate control signals or precursors to control signals, such as the body torque signals 210. The inertial sensor signals 206 may be generated by any suitable type of sensors 122, such as accelerometers, gyros, or the like. Additionally, the pilot inputs may be encoded into the pilot input signals 208. Thus, the body torque signals 210 incorporate one or both of the eVTOL's current position and/or orientation, as well as its desired movements.

At block 306, one or more motor speed signal(s) may be received, such as by the flight controller and/or other associated electronics. In some cases, the indication of the motor speed may be received by the flight controller 120 and/or associated electronics from the motor assemblies 106 themselves. The motor assemblies 106 may provide an indication of its commutation frequency and/or measured angular frequency of its corresponding motors, as measured using any variety of sensors or sensorless mechanism. In some cases, back-EMF generated by the spinning motor, which is generally proportional to the angular velocity of the motor, may be used to determine the motor rotational frequency. In other cases, the flight controller 120 and/or associated electronics may determine the rotation frequency of each of the motor assemblies 106 by monitoring regions of excessive noise and filtering those frequencies.

At block 308, one or more filtered body torque signals may be generated by filtering the one or more body torque signal(s), by one or more notch filters using the one or more motor speed signal(s). Variable frequency notch filter(s) 212 may be used to filter out the frequencies corresponding to motor noise from the body torque signals 210. The variable frequency notch filters 212 may be discrete electronic components, or may be implemented within the flight controller 120 and/or other controllers. If there are eight frequencies to be filtered out (e.g., primary and second harmonic of all of the lift rotor 108 associated motors 202), then there may be eight notch filters 212, each set to filter a particular one of the eight frequencies to be filtered. It will be understood that more or fewer numbers of frequencies may be filtered out of the body torque signals 210. The variable frequency notch filters 212 may be provided with an indication of each of the frequencies for individual ones of the variable frequency notch filters 212 to filter, such as by an indication of frequency carried in motor speed signal(s) 214. Thus, individual variable frequency notch filters 212 may have their notch frequencies set according to the motor speed signals.

At block 310, one or more motor control signals may be generated using the one or more filtered body torque signal(s). The filtered body torque signals 216 may then be input into one or more mixers 218, along with an indication of motor speed, such as the motor speed signals 214, to generate the motor control signal(s) 220. The motor control signals 220 may indicate the desired operation of one or more motors 202 of the eVTOL aircraft 100. For example, the motor control signals 220 may indicate a particular speed at which the motor 202 is to rotate and/or if the motor 202 is to be sped up or slowed down. The motor control signals 220 may be provided to one or more motor controller(s) 222, which in turn, generate commutation signals 224 to power and control the operation of the motor 202. According to examples of the disclosure, to the extent that the filtered body torque signals 216 have a reduced influence of motor noise compared to conventional techniques, by extension, the motor control signals 220, as well as the commutation signals 224 also have a reduced influence of motor noise compared to conventional techniques.

At block 312, one or more motor(s) 202 may be powered based at least in part on the control signals, such as by the motor controllers 222. The motor controllers 222 may include hardware and software that cooperate to provide power to the motor 202 as the commutation signals 224. Commutation signals 224, as used herein, refer to signals that provide both timing and power to the motor 202 to enable the motor 202 to rotate, such as to cause the rotor of the motor 202 to rotate relative to the stator of the motor 202. The inverter may include switched power electronics, such as metal-oxide-semiconductor field effect transistors (MOSFETs) (not shown) or other transistors or switches. The MOSFETs may be arranged as various legs of an inverter, where each leg provides commutation signals 224 to each phase of the stators of the motor 202. In other words, the MOSFETs may be switched in such a manner as to energize the phases of the motor 202 in succession to rotate the permanent magnet of the motor 202. The commutation signals 224 from the MOSFETs may be in any suitable form, such as pulse width modulated (PWM).

As disclosed herein, the method 300 enables the determination of motor control signals 220 for the operation of the eVTOL aircraft 100 with reduced influence of motor noise. Therefore, the method 300 of generating motor control signals 220 by result in more accurate determination of motor control signals compared to conventional methods of determining the same. In turn, the more accurate motor control signals may result in more robust operation of the eVTOL aircraft 100.

It should be noted that some of the operations of method 300 may be performed out of the order presented, with additional elements, and/or without some elements. Some of the operations of method 300 may further take place substantially concurrently and, therefore, may conclude in an order different from the order of operations shown above.

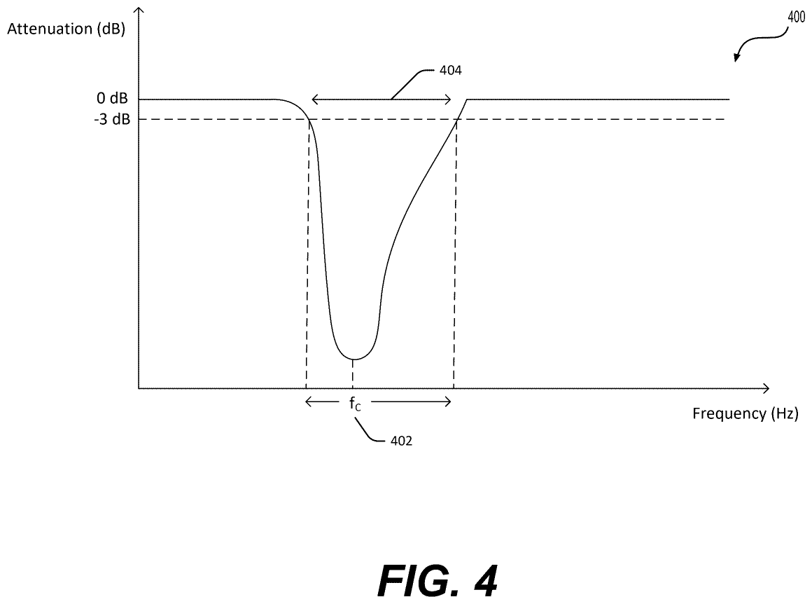

FIG. 4 is a chart depicting an example output transfer function 400 of a notch filter 212 used to generate the motor control signal 220 of the eVTOL aircraft 100 of FIG. 1, according to examples of the disclosure. The notch filters 212 may have a center frequency or notch frequency (f_{C}) 402. The transfer function 400 may be characterized to significantly attenuate components of a signal (e.g., input signal) that have a frequency of the notch frequency 402. The frequency range around the notch frequency 402, as indicated by an arrow, is the bandwidth 404 of the notch filter 212. The bandwidth 404, as demarcated here, is the range of frequencies around the notch frequency 402 where the input signal is attenuated by 3 decibels (dB) (50%) or more. It should be noted that bandwidth can be defined in other ways and/or with other thresholds, and the disclosure is not limited to the aforementioned definition of bandwidth spanning between the 3 dB points. As shown, the bandwidth may or may not be symmetric around the notch frequency 402. In general, the notch frequency operates by attenuating, sometimes significantly attenuating the notch frequency 402 and a band of frequencies (e.g., the bandwidth 404) surrounding the notch frequency 402.

The notch filters 212, as disclosed herein can be tuned to have a variable notch frequency 402. As such, the notch frequency 402 of individual notch filters 212 may be set according to the motor rotational frequency to filter out noise components at those frequencies (primary, harmonics, intermodulation signals) associated with the motor rotational frequency. The notch filters 212, as discussed herein, may be digital notch filters, where the notch frequency 402 may be provided thereto to be filtered from discrete time-series signals (e.g., body torque signals, such as in the form of pitch signals, yaw signals, and/or roll signals). In alternative cases, the body torque signal(s) may be continuous signals. When the various torque signal(s) are continuous and/or analog, the notch filters 212 may also be analog devices, such as tunable inductive-capacitive (LC) notch filters, resistive-inductive (RL) notch filters, and/or tunable resistive-inductive-capacitive (RLC) notch filters.

The bandwidth 404 as the spectral width of the spectral region that is attenuated by the variable frequency notch filter 212, and by extension the quality factor of the notch filter 212, may be any suitable value. For example, in some cases, the bandwidth 404 may be approximately +/−10% of f_{C}. In other cases, the bandwidth 404 may be approximately +/−5% of f_{C}. In still other cases, the bandwidth 404 may be approximately +/−2% of f_{C}. In other cases, the bandwidth 404 may be approximately +/−1% of f_{C}. In some cases, the bandwidth 404 may be within the aforementioned ranges, but may not be symmetric on either side of f_{C}.

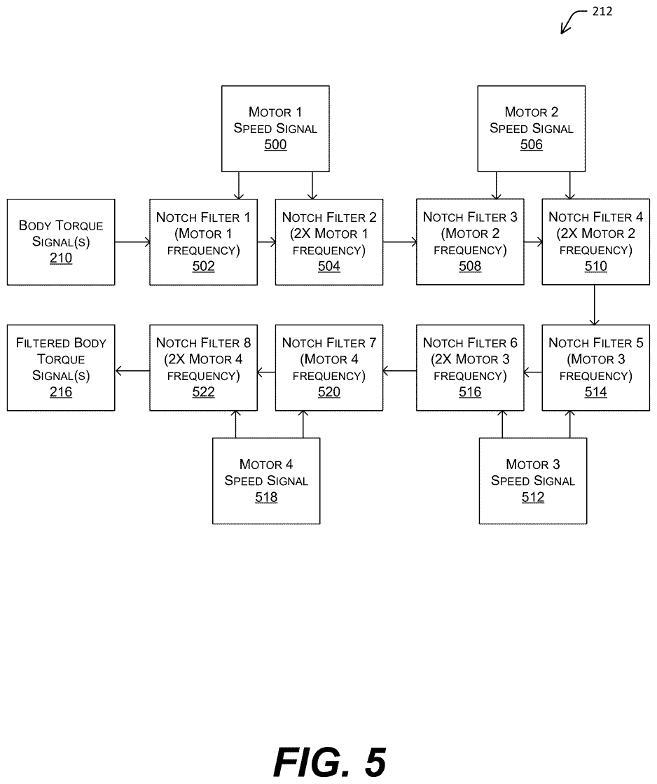

FIG. 5 is an example block diagram depicting the generation of an example filtered body torque signal 216 of a motor 202 of the eVTOL aircraft 100 of FIG. 1 over time, according to examples of the disclosure. In this example, the primary and the second harmonic frequency of four motors 202, representing the motor assemblies 106 of the lift rotors 108, are filtered out of a particular body torque signal 210 to generate filtered body torque signal 216. As shown, the body torque signal 210 may be filtered of a primary frequency and a second harmonic frequency of the first motor 202, for which motor speed signal 500 is provided to a first notch filter 502 and a second notch filter 504. The notch of the first notch filter 502 is set to the primary frequency of the first motor 202 and the notch of the second notch filter 504 is set to two times the primary frequency, resulting in the filtering out of the primary and second harmonic frequencies corresponding to the first motor 202.

The output of notch filter 504 may then be filtered of a primary frequency and a second harmonic frequency of the second motor 202, for which motor speed signal 506 is provided to a third notch filter 508 and a fourth notch filter 510. The notch of the third notch filter 508 is set to the primary frequency of the second motor 202 and the notch of the fourth notch filter 510 is set to two times the primary frequency of the second motor 202, resulting in the filtering out of the primary and second harmonic frequencies corresponding to the second motor 202. The output of notch filter 510 may then be filtered of a primary frequency and a second harmonic frequency of the third motor 202, for which motor speed signal 512 is provided to a fifth notch filter 514 and a sixth notch filter 516. The notch of the fifth notch filter 514 is set to the primary frequency of the third motor 202 and the notch of the sixth notch filter 516 is set to two times the primary frequency of the third motor 202, resulting in the filtering out of the primary and second harmonic frequencies corresponding to the third motor 202. The output of notch filter 516 may then be filtered of a primary frequency and a second harmonic frequency of the fourth motor 202, for which motor speed signal 518 is provided to a seventh notch filter 520 and an eighth notch filter 522. The notch of the seventh notch filter 520 is set to the primary frequency of the fourth motor 202 and the notch of the eighth notch filter 522 is set to two times the primary frequency of the fourth motor 202, resulting in the filtering out of the primary and second harmonic frequencies corresponding to the fourth motor 202.

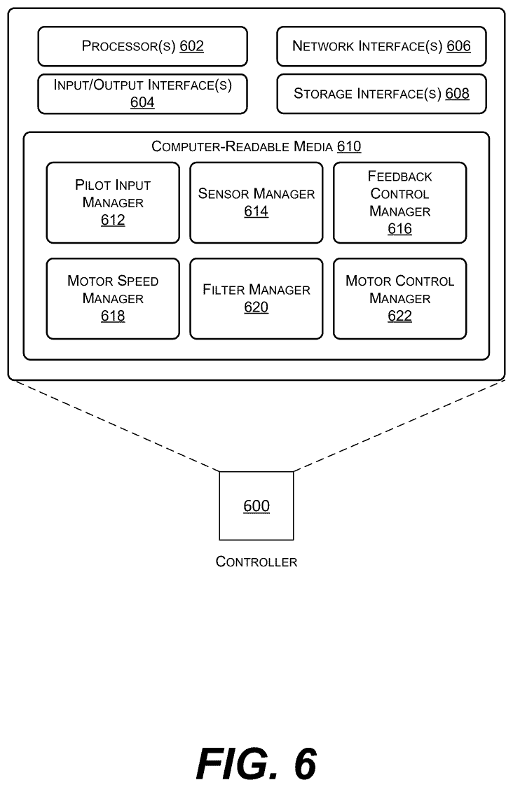

FIG. 6 is a block diagram of a controller 600 to generate a filtered body torque signal 216 of a motor 202 of the eVTOL aircraft 100 of FIG. 1, according to examples of the disclosure. In some cases, the controller 600 may include the flight controller 120. In other cases, the controller 600 may include one or more electronic components (e.g., feedback controller, motor controller, etc.) that provide the functionality of controller 600. In yet other cases, the controller 600 may include flight controller 120 along with one or more other electronic components, such as other controllers and filters. The controller 600 includes one or more processor(s) 602, one or more input/output (I/O) interface(s) 604, one or more network interface(s) 606, one or more storage interface(s) 608, and computer-readable media 610. In examples, the processor(s) 602, I/O interfaces 604, network interface(s) 606, storage interface(s) 608, and/or computer-readable media 610 may be part of an electronic device or computer system.

In some implementations, the processors(s) 602 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 602 may possess its own local memory, which also may store program modules, program data, and/or one or more operating systems. The one or more processor(s) 602 may include one or more cores.

The one or more input/output (I/O) interface(s) 604 may enable the controller 600 to detect interaction with a human operator. For example, the operator may provide task instructions (e.g., intended flight maneuvers) or monitor metrics (e.g., motor speed, motor torque, etc.) from the motor controllers 222. The I/O interface may also enable interaction with human-machine interfaces (HMI).

The network interface(s) 606 may enable the controller 600 to communicate via the one or more network(s). The network interface(s) 606 may include a combination of hardware, software, and/or firmware and may include software drivers for enabling any variety of protocol-based communications, and any variety of wireline and/or wireless ports/antennas. For example, the network interface(s) 604 may comprise one or more of WiFi, cellular radio, a wireless (e.g., IEEE 802.1x-based) interface, a Bluetooth® interface, and the like.

The storage interface(s) 608 may enable the processor(s) 602 to interface and exchange data with the computer-readable media 610, as well as any storage device(s) external to the controller 600. The storage interface(s) 608 may further enable access to removable media or datastores.

The computer-readable media 610 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 610 may be implemented as computer-readable storage media (CRSM), which may be any available physical media accessible by the processor(s) 602 to execute instructions stored on the computer readable media 610. In one basic implementation, CRSM may include random access memory (RAM) and Flash memory. In other implementations, CRSM may include, but is not limited to, read-only memory (ROM), electrically erasable programmable read-only memory (EEPROM), or any other tangible media which can be used to store the desired information, and which can be accessed by the processor(s) 602. The computer-readable media 610 may have an operating system (OS) and/or a variety of suitable applications stored thereon. The OS, when executed by the processor(s) 602 may enable management of hardware and/or software resources of the controller 600.

Several components such as instruction, data stores, and so forth may be stored within the computer-readable media 610 and configured to execute on the processor(s) 602. The computer readable media 610 may have stored thereon a pilot input manager 612, an sensor manager 614, a feedback control manager 616, a motor speed manager 618, a filter manager 620, and a motor control manager 622. It will be appreciated that each of the components 612, 614, 616, 618, 620, 622 may have instructions stored thereon that when executed by the processor(s) 602 may enable various functions pertaining to operating the controller 600, as described herein.

The instructions stored in the pilot input manager 612, when executed by the processor(s) 602, may configure the controller 600 to accept pilot input, such as from pilot control elements in the cockpit 104 of the aircraft 100. This pilot input may be encoded into a pilot input signal 208, as used to generate the body torque signals 210, in a feedback mechanism.

The instructions stored in the sensor manager 614, when executed by the processor(s) 602, may configure the controller 600 to receive signals from one or more sensors 122, such as inertial sensor signals. The inertial sensor signals 206 may be indicative of the position, orientation, velocity, and/or acceleration of the aircraft 100.

The instructions stored in the feedback control manager 616, when executed by the processor(s) 602, may configure the controller 600 to apply the inertial sensor signals 206 to a feedback mechanism, along with the pilot input signals 208, as described in conjunction with feedback controller 204. The result of feedback control may enable the controller 600 to generate body torque signals 210.

The instructions stored in the motor speed manager 618, when executed by the processor(s) 602, may configure the controller 600 to determine the speed of the one or more motors 202, the noise of which is to be attenuated in the body torque signals 210. The motor speed of the one or more motors 202 may be encoded in the motor speed signals 214. The motor speed information may be received from any suitable entity, such as the motor controller 222.

The instructions stored in the filter manager 620, when executed by the processor(s) 602, may configure the controller 600 to operate one or more variable frequency notch filters 212 to attenuate the motor noise from one or more motors 202. The controller 600 may set the variable frequency of the variable frequency notch filters 212 according to the motor speed signals 214.

The instructions stored in the motor control manager 622, when executed by the processor(s) 602, may configure the controller 600 to perform the functions of the motor controller 222. The controller 600 may use the motor control signals 220, as determined according to the procedures disclosed herein to limit the influence of motor noise on motor control, may be used to generate commutation signals 224 to drive the motors 202.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A motor control system, comprising:
a feedback controller configured to receive an inertial sensor signal and a pilot input signal and generate a body torque signal based at least in part on the inertial sensor signal and the pilot input signal;
a first variable frequency notch filter configured to filter the body torque signal to generate a filtered body torque signal, wherein the body torque signal is filtered to attenuate a first frequency of rotation of a first motor; and
a first motor controller configured to generate commutation signals for the first motor based at least in part on the filtered body torque signal and power the first motor using the commutation signals.

2. The motor control system of claim 1, further comprising:
a mixer configured to generate a motor control signal for the first motor based at least in part on the filtered body torque signal, wherein the commutation signals are based at least in part on the motor control signal.

3. The motor control system of claim 1, further comprising:
a second variable frequency notch filter configured to filter the body torque signal to attenuate a second harmonic frequency associated with the first frequency of rotation of the first motor to generate the filtered body torque signal.

4. The motor control system of claim 1, wherein a notch frequency of the first variable frequency notch filter is set to the first frequency of rotation of the first motor.

5. The motor control system of claim 1, further comprising:
a second variable frequency notch filter configured to filter the body torque signal to attenuate a second frequency of rotation of a second motor to generate the filtered body torque signal.

6. The motor control system of claim 5, further comprising:
a third variable frequency notch filter configured to filter the body torque signal to attenuate a third frequency of rotation of a third motor to generate the filtered body torque signal.

7. The motor control system of claim 1, wherein to filter the body torque signal to generate the filtered body torque signal further comprises:
receiving an indication of the first frequency of rotation of the first motor.

8. The motor control system of claim 1, wherein the body torque signal is one of a roll signal, a yaw signal, or a pitch signal.

9. A method, comprising:
receiving, by a feedback controller, a inertial sensor signal;
determining, by the feedback controller and based at least in part on the inertial sensor signal, a body torque signal;
filtering, using a variable frequency notch filter, a first frequency from the body torque signal to generate a filtered body torque signal; and
generating, by a mixer and based at least in part on the filtered body torque signal, a motor control signal to control an operation of a motor.

10. The method of claim 9, further comprising:
generating, by a motor controller and based at least in part on the motor control signal, a commutation signal to power the motor.

11. The method of claim 9, further comprising:
filtering, using a second variable frequency notch filter, a second frequency from the body torque signal to generate the filtered body torque signal.

12. The method of claim 9, further comprising:
receiving an indication of a rotational frequency of the motor, wherein the first frequency is substantially equivalent to the rotational frequency of the motor.

13. The method of claim 9, further comprising:
determining, by a second feedback controller and based at least in part on the inertial sensor signal, a second body torque signal;
filtering, using a second variable frequency notch filter, a second frequency from the second body torque signal to generate a second filtered body torque signal; and
generating, by a second mixer and based at least in part on the second filtered body torque signal, a second motor control signal to control the operation of a second motor.

14. The method of claim 9, further comprising:
receiving, by a second feedback controller, a second inertial sensor signal;
determining, by the second feedback controller and based at least in part on the second inertial sensor signal, a second body torque signal;
filtering, using a second variable frequency notch filter, a second frequency from the second body torque signal to generate a second filtered body torque signal; and
generating, by a mixer and based at least in part on the second filtered body torque signal, a second motor control signal to control the operation of a second motor.

15. An aircraft comprising:
a motor;
one or more controllers configured to:
filter a first frequency from a body torque signal to generate a filtered body torque signal, the first frequency corresponding to a rotational frequency of the motor;
generate, based at least in part on the filtered body torque signal, a motor control signal to control an operation of a motor; and
generate, based at least in part on the motor control signal, a commutation signal to power the motor.

16. The aircraft of claim 15, wherein the one or more controllers are configured to:
filter a second frequency from the body torque signal to generate the filtered body torque signal, the second frequency corresponding to a second harmonic of the rotational frequency of the motor.

17. The aircraft of claim 15, wherein the one or more controllers are configured to:
filter a second frequency from the body torque signal to generate the filtered body torque signal, the second frequency corresponding to a rotational frequency of a second motor.

18. The aircraft of claim 17, wherein the one or more controllers are configured to:
filter a third frequency from the body torque signal to generate the filtered body torque signal, the second frequency corresponding to a second harmonic of the rotational frequency of the second motor.

19. The aircraft of claim 15, wherein the one or more controllers are configured to:
filter the first frequency from a second body torque signal to generate a second filtered body torque signal;
generate, based at least in part on the second filtered body torque signal, a second motor control signal to control an operation of a second motor; and
generate, based at least in part on the second motor control signal, a second commutation signal to power the second motor.

20. The aircraft of claim 19, wherein the one or more controllers are configured to:
filter a second frequency from the second body torque signal to generate the second filtered body torque signal, the second frequency corresponding to a rotational frequency of the second motor.
